(19) United States
(12) Patent Application Publication
(10) Pub. No.: US 2012/0305215 A1
(43) Pub. Date: Dec. 6, 2012

(54) Kearns' cooling blanket

(75) Inventor: James Lawrence Kearns, Jacksonville, FL (US)

(73) Assignee: James Lawrence Kearns, Jacksonville, FL (US)

(21) Appl. No.: 13/199,766

(22) Filed: Sep. 9, 2011

Related U.S. Application Data
(60) Provisional application No. 61/520,151, filed on Jun. 6, 2011.

(51) Int. Cl. F28D 15/00; A62C 35/58; F28F 9/00

(52) U.S. Cl. 165/56; 165/104.28; 169/5

(57) ABSTRACT

This method of cooling provides that water is the primary catalyst for the cooling, rather than air in the standard systems, and provides that in the open system that cooling tubes are placed in the ceiling of the enclosed space or external covered area It provides for lower than 32 degrees Fahrenheit temperature in normal operation parameters in the closed system configuration. Further, it provides for recycling of the water back for reuse by a hot water heater in a normal home use construct. A secondary use of the open system is as a fire control system with the understood heat release valves used with the ceiling cooling tubes. Further, water expelled as condensation is recycled back into the system for use.

This application claims the benefits of provisional patent application No. 61/520,151 filed on Jun. 6, 2011 by the present inventor.

### FEDERALLY SPONSORED RESEARCH

Not Applicable

### SEQUENCE LISTING OR PROGRAM

Not Applicable

### BACKGROUND OF THE INVENTION

### Field of the Invention

This invention relates to an air conditioning system which utilizes a refrigerated system to chill water and pump the water through lines to provide for the primary catalyst for the cooling system and utilization of separate warm and cold tanks to enhance the cooling potential of the system with an external water supply, and additionally makes use of initially cold temperature systems to provide for greater efficiency.

Currently utilized systems make use of an “A” frame system which has a compressor pumping refrigerant coolant and changing it from a gas to a liquid and thus produces the cold by “boiling” the gas when it is changed from a gas to a liquid and back again and works because of the Laws of Thermodynamics.

Other systems use a heat pump to produce heat and cold by moving the cold air from an outside source into the inside and moving the heat out of the internal area again because of the Laws of Thermodynamics.

These current systems use forced air and an “Air Handler” to force air into a room and move the air over the cold service of the “A” Frame. The efficiency of this system is determined by the force of the air in the air handler when passing over the A Frame and the temperature of the A Frame that is cold and the temperature of the A Frame itself. The previous prior art was first developed by Willis Carrier and patented in 1902 which at this time consists of three primary components:
1. A Compressor which compresses a gas and changes it into a liquid and back to a gas
2. A Condenser which transfers the heat outside
3. An Evaporator which allows the liquid to evaporate back into a gas and extract heat.

The prior art of all primary main systems used today, therefore, rely on air forced through a coil to produce the cold air that is filled with the chemical that is now made cold by the expansion and contraction of the gas.

This system differs from all prior art, and is not obvious because it relies on water that is already cold from an outside source and cooled more in a freezer chamber and ran through a ceiling or box to force air around to produce the cooling of the air. Additionally the current or prior art does not make use of water as the primary catalyst for cooling. Further, once the water is heated slightly, the water is then transferred for use by the hot water heater in a normal home use construct.

The use of cooling tubes in a ceiling provide for lower temperatures in an entire room without the use of a fan at all times due to the Laws of Thermodynamics where heat will move only to the cold areas, thus the temperature is more readily controlled in a room or enclosed space.

This system could double as a sprinkler system for fire control by utilizing the systems that are currently used that allow water to flow when sufficient temperatures are reached and melt the sprinkler head release, in public buildings and hotels, etc.

Other similar systems that make use of water to provide cooling in a blanket configuration fail to utilize an outside source of initially cold water from the municipal water supply or an underground well to provide for greater efficiency of the system. Additionally, they fail to make use of a cold and warm tank to provide for greater efficiency of the system and use of the warmer water for the hot water supply source.

One such system is U.S. Pat. No. 5,190,032, published on Mar. 2, 1993 by Zacoi and provides for fluid circulation inside chambers of a blanket. This system differs because it fails to utilize an external outside source for the cooling and does not involve further cooling by a freezer system.

Another type of system that was patented by Nicholson, U.S. Pat. No. 5,165,127 on Nov. 24, 1992 utilized two separate chambers, one being filled with ice water to provide for cooling. This system also differs and fails to utilize an outside source of cold water and additional cooling inside a freezer chamber to produce the cold. Neither system provides that a larger coil system placed in the ceiling of a room will provide for cooling when the water being pumped into the system is previously cooled by a freezer system.

The obvious use of the refrigerator/freezer system comprising the previously developed and patented systems is required but, the unobvious systems which provide a “flash of genius” are the use of external outside sources of initially cold temperature areas, such as a municipal or well water supply, and the transfer of the heated water back to the hot water system. Additionally, the use of tubes which are cold to be placed in a ceiling, differs from current systems, as this was previously only made use of as a heating system in a home and not as a cooling system. Further the use of antifreeze in the water to stop freezing and provide for lower than 32 degrees to produce greater efficiency

Several types of “cooling blanket” systems have been patented, such as U.S. Pat. No. 5,989,285 by DeVilbiss et al, and U.S. Pat. No. 5,304,213 to Berke et al, and U.S. Pat. No. 5,265,599 to Stephenson et al, as well as others that will provide a cooling temperature for a blanket configuration, but all suffer from the same basic disadvantage in that is for a small enclosed space and do not make use of an external water supply and/or a refrigerator/freezer system and separate tanks for cold and hot water and a larger area such as a room or covered outside area.

Therefore, all heretofore utilized “cooling blanket” configurations suffer from a number of disadvantages:
(a) They are used primarily for the purpose of keeping an individual cool in a small area and the person must be under the blanket configuration in order to be kept cool.
(b) The current and prior art do not take into account the use of an external cold water supply that will provide additional efficiency for the system, nor discharge the warm water to the hot water supply.
(c) The use of two external tanks, the size of which will help to increase the efficiency of the system, the larger the tanks, the greater the expected efficiency.
(d) The current and prior art does not make use of the system placing cooling tubes in the ceiling to provide for comfort of an entire room or covered outside area such as an arena or bleachers for a sporting event or show.
(e) The secondary configuration (from the previous submitted provisional patent submission) shows a smaller version of the system that will provide cooling to a smaller area, similar to the systems that are in use today, but the use of an external water supply and secondary hot tank will provide greater efficiency than the prior art and the current and prior art does not make use of externally cold temperatures to help to provide for cooling.

### SUMMARY OF THE INVENTION

A method of cooling an enclosed or external covered space comprising an open or closed system utilizing water as the primary catalyst of cooling rather than the use of forced air and further comprising the use of external tanks and a pumping system to produce in the closed configuration lower than 32 degrees Fahrenheit or 0 degrees Centigrade in the normal operation parameters. In the open system configuration an external source of naturally occurring cooler temperature water supplies and insulated tanks and cooling tubes in a ceiling or overhead to provide for greater efficiency of the systems due to closer proximity of the cooling tubes. Further, due to the overhead configuration and external water source, the system can be doubled as a fire control system when heat release valves are used in the cooling tubes.

### DRAWINGS—FIGURES

FIG. 1 of 4, shows the open system configuration of the system with the use of external tanks with cold water supplied from an existing well or municipal water supply and cooled in an internal tank within the freezer chamber and transferred as claimed in claim 3 between the two tanks to provide for cold water temperatures to be transferred into the cooling tubes in item 16 with a fan as in Item 3 that will transfer the cold temperatures to an enclosed room or area

Item 1 shows the timed release pump that transfers the heated water back into the warm water tank after it is heated as claimed in claim 3 with an electric cord not shown for clarity.

Item 2 shows the drip pan with exit of the condensation not illustrated as required

Item 3 is the fan that helps distribute the cold air over the tubes with an electrical cord not shown for clarity.

Items 4 and 14 shows the lines transferring back to the warm (or cold) water tanks to be a partial or complete supply for a standard hot water tank, in a normal home use construct as claimed in claim 3.

Item 5 shows the pump transferring fluid back into the main tank to circulate the water between the tanks that are represented by claim 3 with an electrical cord not shown for clarity.

Item 6 is representative of an open view of a freezer which has a tank inside to provide for cooling of the fluid and transfer to the other insulated tank to maintain a cold temperature of the water as claimed in claim 3. Internal operating mechanisms such as a compressor, and standard systems associated with a freezer and electrical cord are understood, therefore not illustrated.

Item 7 represents a standard float stop when the water level reaches the required level for operation from the external water supply as claimed in claim 3 to provide an external water source for the freezer system which will have cooler static temperatures as claimed in claim 3.

Item 8 is representative of the external water supply line with cooler than outside air temperatures as claimed in claim 3.

Item 9 as claimed in claim 3 cold water that is above 32 degrees Fahrenheit with the action of the freezer to provide for further cooling of the static temperature of the water.

Item 10 represents the tanks into which water is transferred between the systems as depicted in claim 3. The size of these tanks are variable in relation to the efficiency required.

Item 11 is representing the pump that will return the water back into the hot water heater once the water is returned into the tank and has sufficient pressure to supply the hot water tank through Item 12 which is depicts the pipe for the warm water supply and Item 13 which depicts the overflow if the tank becomes to full. Item 15 represents the warm water that has been transferred back into the system as claimed is clam 3.

Item 17 is representative of the warm water tank.

Item 18 is representative of a pump that moves the water into the cooling tubes after the timed release pump has expelled the warmer water into the tank.

FIG. 2 of 4, shows an exploded view of the configuration of the tubes in the ceiling as claimed in claims 2 and 4 with the ceiling area depicted in Item 1 and as outlined in claims 2, 3, & 4.

Item 2 represents the drip catch which will catch any condensation from the tubes and expel it out an exit line depicted by Item 8.

Item 3 represents the cooling tubes in the ceiling configuration as outlined in claims 2, 3, & 4.

Item 4 represents the timed release pump with an open system as outlined in claims 3 & 4 where water is being returned back to the warm tank after it becomes heated.

Item 5 represents the line from the cold tank being pumped into the cooling tubes in the ceiling so that heat may be transferred into the tubes from the room by the Laws of Thermodynamics as outlined in claims 1 through 4.

Item 6 is representative of the return line back into the warm tank after the water is heated as outlined in claims 3 & 4.

Item 7 represents the fans that are above the cold lines to provide for cooling “sink” and will provide for greater efficiency and in closer proximity to the warm area to increase the cooling efficiency of the system as outlined in claims 1 through 4.

Item 8 is representative of the drip catch exit lines where condensation is being removed from the area as understood by the operation of the system.

FIG. 3 of 4 is a non-explosive view of the open system configuration ceiling tubes. It is identical to FIG. 2 in scope and type but shows a view of hidden systems and not expanded.

Item 1 is representative of the ceiling as outlined in claims 2, 3, & 4.

Item 2 represents the drip catch which will catch any condensation from the tubes and expel it out an exit line depicted by Item 8.

Item 3 represents the cooling tubes in the ceiling configuration as outlined in claims 2, 3, & 4.

Item 4 represents the timed release pump with an open system as outlined in claims 3 & 4 where water is being returned back to the warm tank after it becomes heated.

Item 5 represents the line from the cold tank being pumped into the cooling tubes in the ceiling so that heat may be transferred into the tubes from the room by the Laws of Thermodynamics as outlined in claims 1 through 4.

Item 6 is representative of the return line back into the warm tank after the water is heated as outlined in claims 3 & 4.

Item 7 represents the fans that are above the cold lines to provide for cooling “sink” and will provide for greater efficiency and in closer proximity to the warm area to increase the cooling efficiency of the system as outlined in claims 1 through 4.

Item 8 is representative of the drip catch exit lines where condensation is being removed from the area as understood by the operation of the system.

FIG. 4 of 4 shows a view of the closed system configuration in which water with antifreeze added is transferred between tanks and the freezer system to provide for lower than 32 degrees as claimed in claims 1 & 2.

Item 1 is representative of the cooling tubes that are filled with water with antifreeze added and transferred between the tanks and returned back into tank number 6. In this closed system configuration, lower than 32 degrees Fahrenheit temperatures is accomplished for normal operation parameters as outlined in claims 1 & 2.

Item 2 is representative of the fan that blows air across the cooling tubes to provide for greater cooling potential and efficiency with, as required, air ducts (not shown but understood) to convey the cold air into adjoining rooms or floor levels as outlined in claims 1 & 2.

Item 3 is representative of the drip pan that is understood (although it is not shown in the drawing) to have an outlet for the condensation from the cooling tubes.

Item(s) 4 is representative of the pumps with move the fluid between the tanks and into the external cooling tubes to provide for lower than 32 degrees Fahrenheit temperatures for normal operation parameters as outlined in claims 1 & 2. The electrical cords needed to supply 110 or 220 volts of power to the pumps are not shown but understood and are omitted for clarity of the drawings.

Item(s) 5 are representative of the insulated tanks that have cold water stored for transfer to the cooling tubes and transfer the cold water into the cooling tubes and attain lower than 32 degrees Fahrenheit temperatures due to the continuous flow between the tanks and sufficient size of the tanks to maintain such temperatures, as outlined in claims 1 & 2 of the closed system.

Item 6 is representative of the freezer system with an open view that chills the water for lower than 32 degrees Fahrenheit temperatures as outlined in claims 1 & 2 of the closed system configuration with the systems of internal compressors, evaporator, and condenser, not shown but understood as a modified freezer with the inner workings of a freezer understood and therefore omitted for the clarity of the drawings.

Item(s) 7 is representative of the chilled water and antifreeze mixture to prevent freezing as outlined in claims 1 & 2.

Item 8 is representative of the return lines that transfer the fluid between the tanks.

### DETAILED DESCRIPTION AND PREFERRED EMBODIMENT FOR THE CLOSED SYSTEM CONFIGURATION

A preferred embodiment of the present invention is a system that will chill water down to pass through tubes and transferred into a room or enclosure to provide high cooling of the enclosed area. In the closed system preferred embodiment the system will include only one external tank and no external water supply so that the liquid is transferred back and forth and through the external tubes to maintain extremely cold temperatures. As no warm water tank is used, then antifreeze will be used to maintain temperatures at lower than 32 degrees Fahrenheit, or 0 degrees Centigrade, whereas the current technologies cannot allow for greater than freezing of the A frame in order for the system to function properly as outlined in claims 1 & 2 and depicted in drawing FIG. 4.

This is accomplished by the use of a modified freezer chamber 6 with a water tank inside the confines of a sealed chamber (closable lid with adequate insulating qualities) with a modified cooling system which would generally be the standard freezer type system components with systems which achieve the temperature to be below 0 degrees Fahrenheit and an external tank that allows for transfer between the two tanks so that the temperature achieved in both tanks is below 32 degree Fahrenheit as depicted in FIG. 4 and claimed in claims 1 & 2, and capable of maintaining a constant temperature at below freezing and transfer to the cooling tubes depicted in FIG. 4. Item 1 in FIG. 4 is representative of the tubes that are passed in front of the fan illustrated in Item 2 in FIG. 4 and coiled similar to the depiction shown in FIG. 3 and Item 3, except that this depiction shows a side view of the system configuration and is not of the closed system configuration. FIG. 4, Item 3 is representative of the drip pan that will catch any condensation from the cooling tubes with understood exit lines from the drip pan to an outside area through a pipe or recycled back into tank 10 for use.

The water, treated with antifreeze as depicted in Item 7, to guarantee that it does not freeze, is pumped by the systems depicted in pumps 4 to provide continuous circulation of the water and returned by the lines 8 into the insulated chambers depicted in Item(s) 5.

### Detailed Description of the Preferred Embodiment for the Open System Configuration

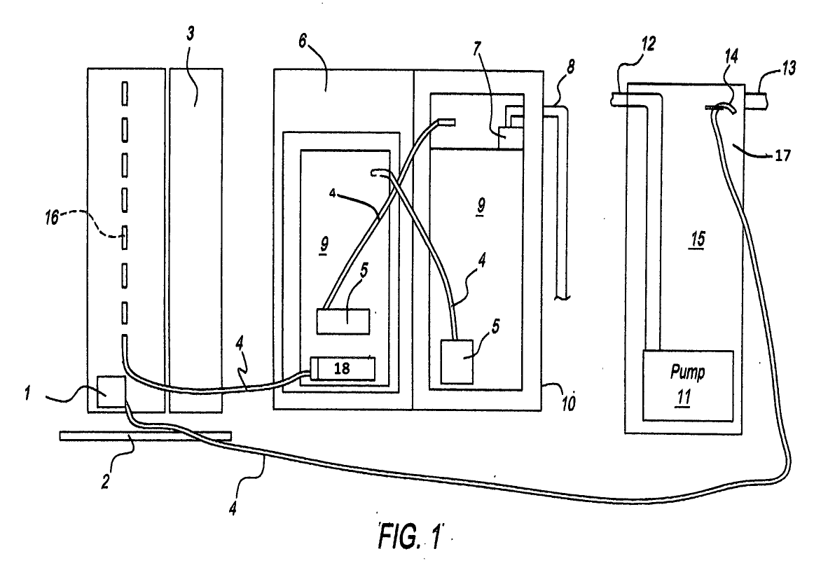

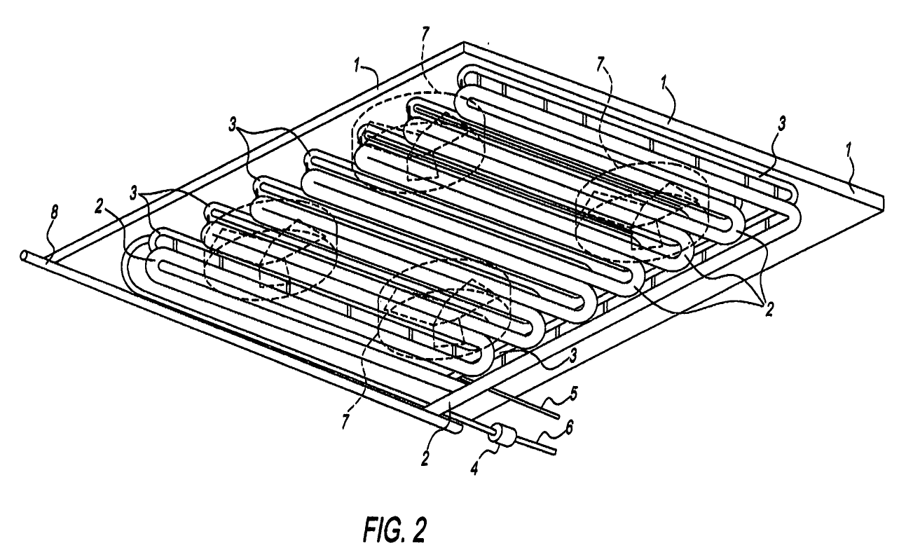

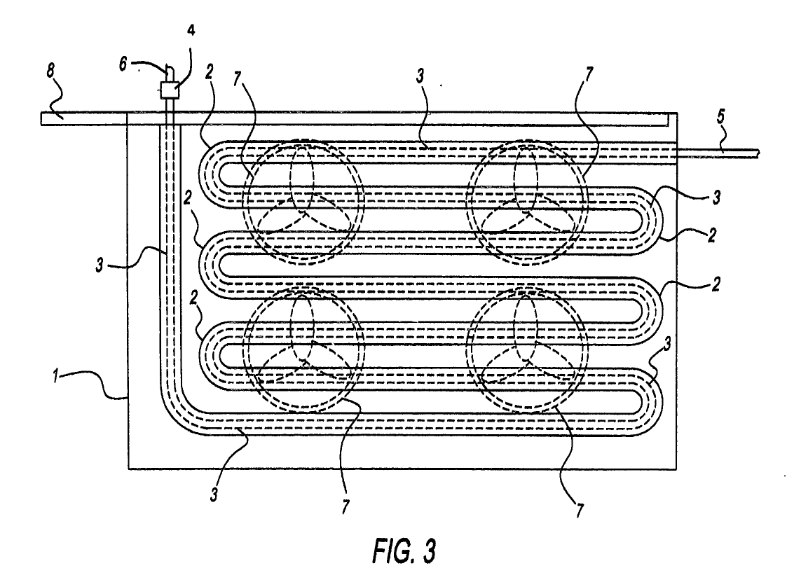

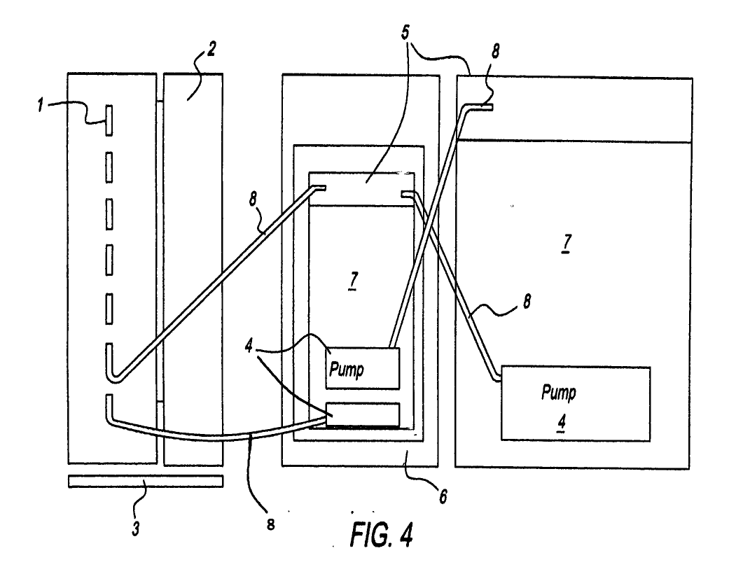

The open system configuration preferred embodiments consist of a method of cooling a larger enclosed space or covered outside area such as a stadium or theater which may be partially covered and consist of the following components, as outlined in FIGS. 1, 2 & 3. Item 6 depicts the freezer system configuration which depicts the use of a modified freezer chamber 6 with a water tank inside the confines of a sealed chamber (closable lid with adequate insulating qualities) with a modified cooling system which would generally be the standard freezer type system components with systems which achieve the temperature to be below 0 degrees Fahrenheit and insulated internal and external tank(s) 10 to allow for the flow of untreated water between the tank(s) 10 and out through the coiled tubes depicted by 16 in FIG. 1, Item 3 in FIG. 2 and Item 3 in FIG. 3 and outlined in claim 3. The untreated water being transferred between the freezer tank 10 and the cooling tubes 16 or 3 (dependent upon configuration) and transferring back through return lines 4, recycles the water back through the system and into the warm water tank 17. This is accomplished through the use of a timed release pump (Item 1 in FIG. 1 and Item 4 in FIGS. 2 and 3) depending on configuration of the system, which will allow for the water once heated slightly (dependent upon temperature) to be recycled back through the system for use with a normal hot water system in a standard home use construct as claimed in claim 3

The drip catch shown as Item 2 in FIG. 1 and Item 2 in FIGS. 2 and 3 (depending on configuration of a horizontal or vertical construct) and the exit line shown as Item 8 in FIGS. 2 and 3, but not shown in FIG. 1 due to the view of the system would provide for exit of expelled condensation fluids from the system and unfreezing of the water is accomplished by the use of fans depicted as Item 3 in FIG. 1 and Items 7 in FIGS. 2 and 3. The fans 3 and 7 also move the air into the room or outside covered area to produce a greater cooling effect.

The pumps 5 depicted in FIG. 1 move the water between the tanks and maintain the proper level of the water in the tanks 10. When the water level is depleted, the water would be transferred into the tank 10 though Item 7 in FIG. 1 and by Item 8 in FIG. 1 which is depicting the line from the external water source, either a well or municipal water supply, as claimed in claim 3. The chilled water 9 in FIG. 1, is transferred continuously between the two or more insulated tanks 10 to produce the greatest cooling effect possible from the freezer system 6.

The water is pumped out through the pump 18 which is imbedded in the cooling tank 10 and is pumped out through the coiled lines 16 so that it can be transferred into the warmer area to cool it. After it warms slightly, this warmer water 15, is transferred by the timed release pump 1 through line 4 and exits at 14 into the warm water tank 17. Pump 11 transfers the warmer water through 12 to the hot water heater to be utilized for hot water once heated to the desired temperature by the hot water heater.

Not shown, but understood, is the recycling of the condensation water expelled at the drip catch 2 or 3 and recycled back into the system into the external tank 10 through the use of a pump not shown or simply by gravity fall in configuration shown in FIGS. 2 and 3 through a line 4. Should the tank 17 become to full, an overflow 13 is provided to expel excess water as waste, which can be recycled as irrigation water.

FIGS. 2 & 3 are different views of the same thing (Figure being an exploded view and 2 a normal view configuration) showing the continuation of the lines 16 from the open system configuration and continuing along as chilled water 9 enters at 5 and flows along on the tubes 3 to be expelled out at 6 after the timed release pump 4 transfers the water through the lines 4 and into the warm water tank 17. Item 1 is just representative of the ceiling and the fans 7 blow air across the tubes 3 while the drip catch 2 allows water from condensation to drop into it and expel it at where it is recycled back into the cold tank(s) 10.

I claim:

1. Independent claim of lower than 32 degrees Fahrenheit, depicted in FIG. 4 to cool a smaller area: A method of cooling a smaller area using a cooling chamber with water as the primary catalyst for cooling by passing water with antifreeze in the water to inhibit freezing of the water through tubes to provide for lower than 32 degrees Fahrenheit or 0 degrees Centigrade in static temperature during standard operating mode.

2. Independent claim of cooling tubes placed in a ceiling with lower than 32 degrees Fahrenheit depicted in a closed system as depicted in FIG. 4. Cooling tubes placed in the ceiling of a room and backed by a fan system will produce a cooling effect that will be more efficient than currently utilized technologies, due to the proximity of the cooling tubes and the lower than 32 degrees Fahrenheit or 0 degrees Centigrade when antifreeze is added to the water assuming a closed system without external water supply during standard operating mode.

3. Independent claim of recycling of warmed water back into the system to be used by a hot water heater to decrease the electrical use of the hot water heater in an open system as depicted in FIGS. 1, 2, and 3: In an open system configuration, the system is utilizing naturally occurring colder temperatures from external sources and returning warmer water back into the warm water tank for reuse.

4. Dependant claim of the secondary use of the system as a fire control system: In the open system configuration the system can double as fire control due to an external water supply and cooler temperatures for the water supply, thus providing for better fire control due to the lower temperature of the water when heat release valves are used with the system.

5. Dependant claim of water expelled as condensation recycled. The clean water from condensation is returned back for use to the cold water tank(s)
